(19) United States
(12) Patent Application Publication
(10) Pub. No.: US 2024/0162852 A1
(43) Pub. Date: May 16, 2024

(54) CONNECTION SYSTEM OF A TRANSMISSION ROD FOR SOLAR TRACKERS

(71) Applicant: TRINA SOLAR, S.L.U., Madrid (ES)

(72) Inventors: Juan Manuel GÓMEZ GARCÍA, Madrid (ES); Miguel ESPEJO LABAO, Madrid (ES); Daniel GONZÁLEZ GARCÍA, Madrid (ES)

(21) Appl. No.: 18/495,315

(22) Filed: Oct. 26, 2023

(30) Foreign Application Priority Data
Nov. 11, 2022 (ES) U 202231874

(51) Int. Cl. H02S 20/32; F16D 3/26

(52) U.S. Cl. CPC H02S 20/32; F16D 3/26

(57) ABSTRACT

A connection system of a transmission rod for solar trackers of rows of solar panels, the transmission rod of which connects a main rotation shaft to a motorised rotation module to a driven shaft with a rotation module without a motor, being connectable to the rotation modules by universal joints that are fastened to the connection output, wherein the universal joint has at one connection end corresponding to the connection output, and at the other end of the universal joint corresponding to a tubular connection output with a polygonal cross section for connection with the transmission rod correspondingly having a polygonal configuration, and with a first end longitudinally slidably connectable to the connection output of a first universal joint and with a second end fixedly connectable to the connection output of a second universal joint.

### CROSS-REFERENCE TO RELATED APPLICATION

This application claims priority of Spanish Application No. 202231874, filed Nov. 11, 2022, the contents of which is incorporated herein by reference.

### TECHNICAL SECTOR

The present invention relates to the industry dedicated to solar trackers for photovoltaic solar panels, and more specifically to the connection system of the transmission rod of solar trackers with at least two rows of solar panels.

### STATE OF THE ART

To achieve an effective transmission of the movement and better adaptability to the different terrain in which solar trackers can be installed, solutions are known in which motorised rotation modules are used to drive the rotation shafts of the solar trackers, which are connected to other rows by means of transmission rods that transmit the movement of the motorised rotation module to a driven shaft of the adjacent solar tracker. The rotation of all the solar panels is thereby synchronised and they adapt with greater ease to the terrain.

An example of this type of solution is found in the Utility Model document ES1271451, which deals with a solar tracker with a transmission rod that connects two rows of solar trackers, connected by universal joints to the corresponding rotation modules of each row of solar trackers. Said rod being a rod with a circular cross section made up of at least two rods joined by an intermediate junction that allows the distance to be adjusted in the assembly of the transmission rod by means of slotted holes.

However, the problem arises that there are difficulties during assembly derived from the necessary junctions between the different parts of the rod for the fastening thereof to the universal connection to the rotation module, and due to the numerous screws to be used for the fastening between the parties.

In light of the described disadvantage or limitation of the currently existing solutions, a solution is necessary that allows greater ease of assembly while providing a safe and effective transmission of movement.

### OBJECT OF THE INVENTION

In order to meet this objective and solve the technical problems discussed so far, in addition to providing additional advantages that can be derived later, the present invention provides a connection system of a transmission rod for solar trackers with at least two rows of solar panels, the transmission rod of which connects a main rotation shaft with a rotation module with a motor to a driven shaft with a rotation module without a motor, said transmission rod being connectable to the rotation modules by means of universal joints that are fastened to the connection output of the rotation module, characterised in that the universal joint has at one end a connection corresponding to the connection output of the rotation module, and at the other end of the universal joint corresponding to a tubular connection output with a polygonal cross section for connection to the transmission rod, the transmission rod having a corresponding polygonal configuration, and with a first end of the transmission rod longitudinally slidably connectable to the connection output of a first universal joint and to a second end of the transmission rod fixedly connectable to the connection output of a second universal joint.

Due to this configuration, the assembly process is facilitated since fewer parts are used than in known solutions that have tube junctions. The torsional stresses are not absorbed by the screwed joints of the junctions or the screw fastenings of the rod to the universal joints as in the state of the art, but rather by the polygonal cross section of the rod and the connection output of the universal joint, said torque transmission is possible by eliminating the joining screws. The joint is provided with the longitudinally sliding connection between the rod and the universal joint connection output, the length of which is fastened with a fixed joint at the other end of the rod once connected to the other universal joint. In this way, a single rod is necessary instead of several sections, said rod with a polygonal cross section also having better mechanical behaviour than the rod with a circular cross section.

In turn, the reduction in screws and better mechanical behaviour prevent or reduce vibrations in the transmission of movement between rotation shafts, reducing maintenance and extending the useful life of the installation.

Preferably, the transmission rod with a polygonal cross section will be square, facilitating manufacturing and providing good mechanical behaviour.

According to a feature of the invention, the connection output of the first universal joint is adjustable by snap fit of the transmission rod. This snap fit facilitates assembly by adjusting the insertion of the transmission rod into the output of the universal joint to the desired length without movement during assembly. It is also contemplated that the adjustment length of the transmission rod at the outlet of the universal joint can be fastened by mechanical means according to predetermined positions.

Likewise, it is intended that the fastening of the connection outlet of the second universal joint is carried out by means of a through screw through a through hole of the connection outlet of the second universal joint coinciding with a through hole of the second end of the transmission rod. This means that, once the transmission rod is positioned with its sliding adjustment, it is easily fastened to prevent its longitudinal movement by simply positioning the through screw.

According to another aspect of the invention, the first universal joint is fastened to the connection outlet of the rotation module by means of a grub screw. This configuration provides a simple rod disconnection system that, by removing the grub screw, allows the adjustable universal joint to be released, allowing for simple disconnection, which facilitates maintenance.

### DESCRIPTION OF THE FIGURES

FIG. 1 shows a perspective view of a dual-row solar tracker with the transmission system object of the invention.

FIG. 2 shows an elevation view of a transmission rod for connecting a rotation module of a motorised rotation shaft to a rotation module of a driven rotation shaft for an example embodiment of the invention.

FIG. 3 shows a top view of the exemplary embodiment of FIG. 2.

FIG. 4 shows an exploded elevation view of one end of the transmission rod joined to the rotation module by means of a first universal joint.

FIG. 5 shows a view like that of FIG. 4 in the assembled position.

FIG. 6 shows an exploded elevation view of the other end of the transmission rod joined to the rotation module by means of a second universal joint.

FIG. 7 shows a view like that of FIG. 6 in the assembled position.

FIG. 8 shows the detailed view of the first universal joint joined to the connection output of the rotation module.

### DETAILED DESCRIPTION OF THE INVENTION

In light of the aforementioned figures, and in accordance with the adopted numbering, a non-limiting preferred exemplary embodiment of the invention can be seen therein, which comprises the parts and elements indicated and described in detail below.

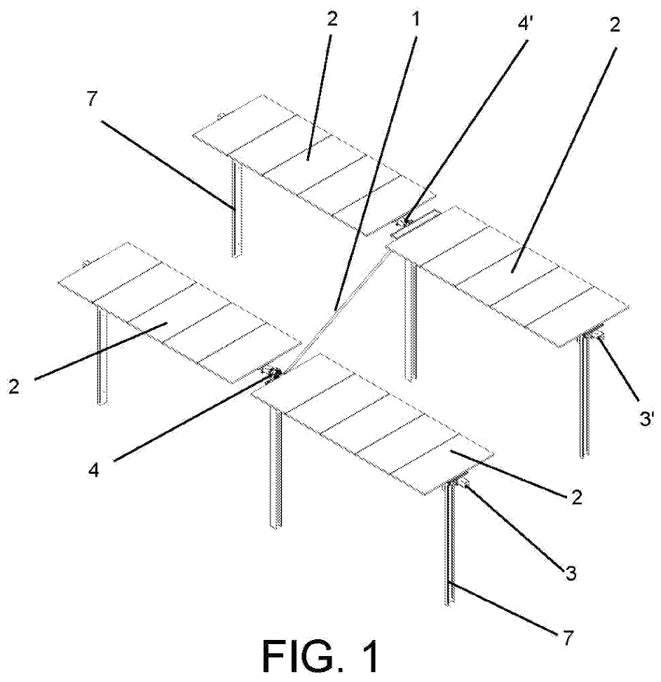

As can be seen in the perspective view of the general installation of solar panels in FIG. 1, due to the orography of the location and to synchronise the rotation of the solar panels (2) of solar trackers in which a rotation shaft (3, 3′) supported on the ground by posts (7) transmits the movement to the solar panels (2) themselves; for the practical example of a dual-row tracker, a transmission rod (1) is used, which transmits the movement of rotation of a main rotation shaft (3) driven by a motorised rotation module (4), to a driven shaft (3′) through its rotation module (4′) without a motor.

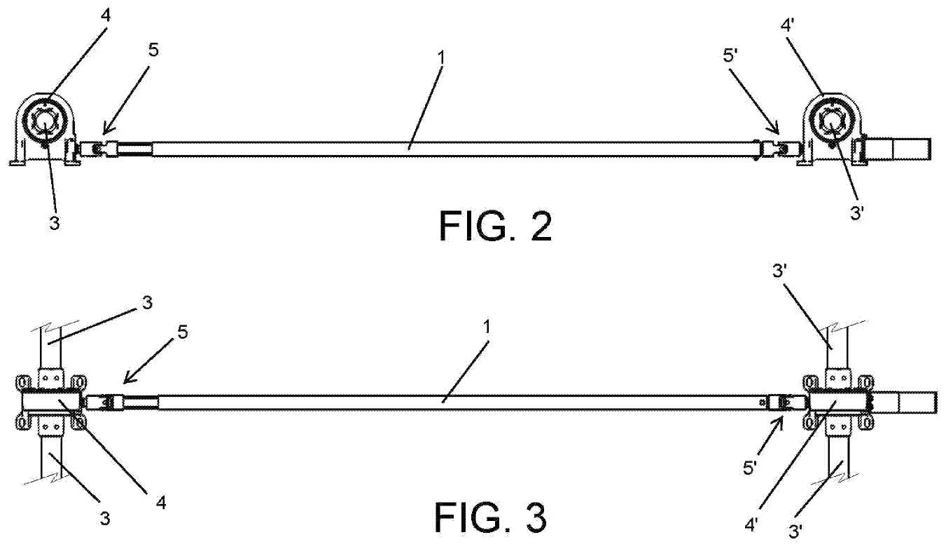

In order for the transmission of movement to be smooth and without vibrations, the connection system of the transmission rod (1), as can be seen in FIGS. 2 and 3, comprises a first universal joint (5) for joining one end of the rod (1) to the motorised rotation module (4), and a second end of the rod (1) fastenable to the rotation module (4′) of the driven shaft (3′) by means of a second universal joint (5′).

The particularity of this transmission rod (1) is its polygonal cross section configuration, specifically for the practical example shown in the figures, a square cross section.

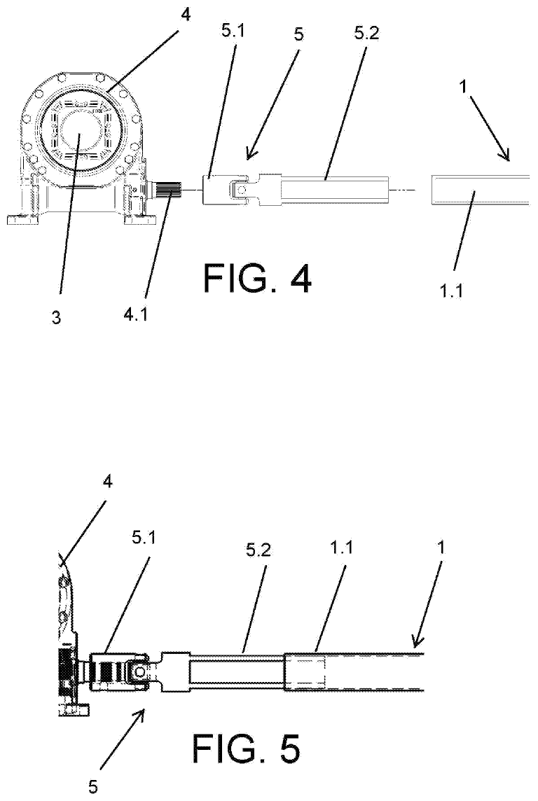

Thus, as can be seen in FIG. 4, the first universal joint (5) comprises a connection end (5.1) with a circular cross section corresponding to the connection output (4.1) of the motorised rotation module (4). This connection output (4.1) preferably has a grooved cylindrical configuration that facilitates the connection of the first universal joint (5) producing a correct transmission of the rotation movement.

As seen in FIGS. 4 and 5, at the other end of the first universal joint (5), it comprises a connection output (5.2) with a square cross section configuration corresponding to the square configuration of the transmission rod (1). A first end (1.1) of the transmission rod (1) thereby being slid longitudinally (in the longitudinal direction of the rod) onto the connection outlet (5.2) of the first universal joint (5). This connection between the transmission rod (1) and the connection output (5.2) of the first universal joint (5) will preferably be adjustable by pressure to facilitate assembly work, such that a prefastening is achieved that prevents the rod (1) from easily coming out of the connection output (5.2).

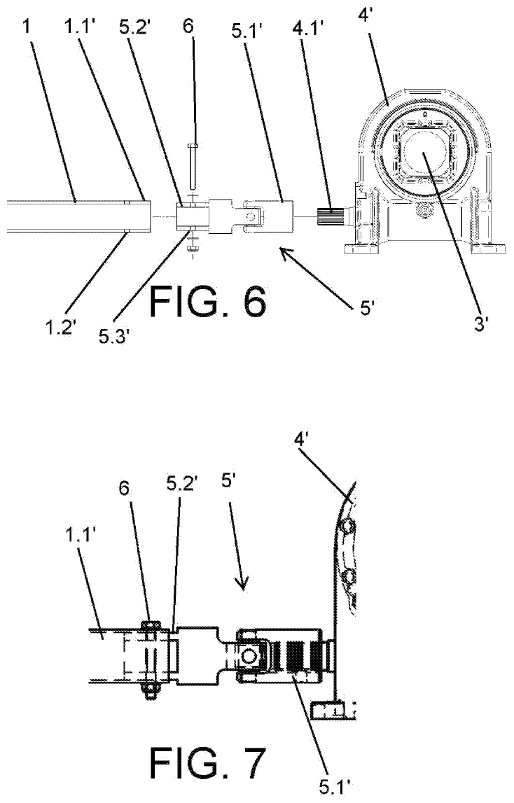

Furthermore, and according to FIGS. 6 and 7, the connection system of the transmission rod (1) comprises a second universal joint (5′) for fastening the second end (1.1′) of the transmission rod (1) to the rotation module (4′) of the driven shaft (3′). Similarly to the first universal joint (5), the second universal joint (5′) comprises a connection end (5.1′) with a cylindrical configuration corresponding to the connection output (4.1′) of the rotation module (4′) of the driven rotation shaft (3′). This connection output (4.1′) preferably has a grooved cylindrical configuration that facilitates the connection of the second universal joint (5′) to the rotation module (4′).

At the other end of the second universal joint (5′), it comprises a connection output (5.2′) with a square cross section configuration corresponding to the square configuration of the transmission rod (1). The second end (1.1′) of the transmission rod (1) is thereby inserted into the connection output (5.2′) for fastening by means of a through screw (6) that passes through the through holes (1.2′) of the transmission rod (1) and the through holes (5.3′) of the connection output (5.2′).

There is therefore a connection system of the transmission rod (1) that facilitates assembly, such that, firstly, the first universal joint (5) is fastened to the motorised rotation module (4) by inserting the connection end (5.1) into the grooved cylindrical connection output (4.1). Next, the first end (1.1) of the transmission rod (1) with a square cross section is slidably inserted into the connection output (5.2) with a square cross section, preferably having an adjustment length of about 125 mm. During this process, the transmission rod (1) is inserted abutting against the universal joint (5) in an inclined position, then the rod (1) is arranged in a horizontal position and the rod slides until it is inserted into the second universal joint (5′) which will have previously been fastened to the connection output (4.1′) of the rotation module (4′) of the driven rotation shaft (3′).

Once the second end (1.1′) of the transmission rod (1) has been inserted into the connection output (5.2′) of the second universal joint (5′), it is fastened using a through screw (6) such that it prevents the longitudinal movement of the rod (1) on the connection output (5.2). This configuration allows the use of a single transmission rod (1) and significantly reduces the screws necessary for assembly, resulting in greater ease of assembly and a smooth transmission of movement without the vibrations that could be produced by the misalignment of the various screws used in the joints of known solutions.

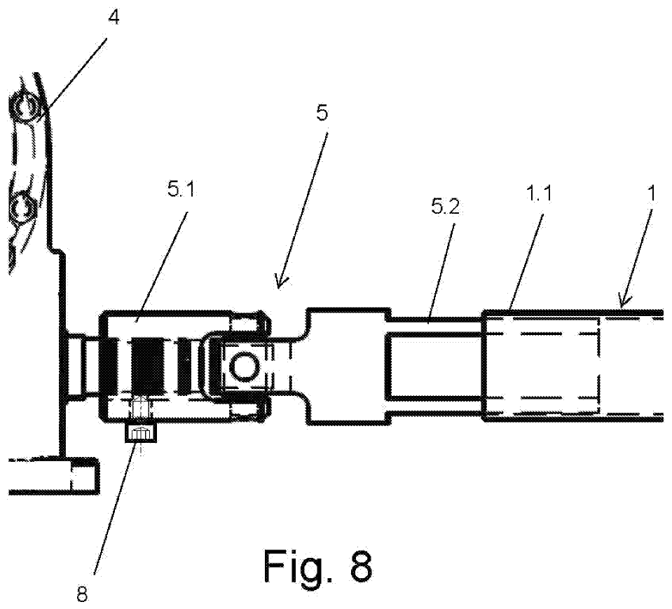

Furthermore, as can be seen in FIG. 8, it is intended for the fastening between the connection end (5.1) of the first universal joint (5) and the connection output (4.1) of the motorised rotation module (4) to be made with a grub screw (8), providing a good disconnection system of the transmission rod (1). In order to perform the disconnection, first, the grub screw (8) is removed, such that the first adjustable universal joint (1) can be released, leaving the through screw (6) of the second universal joint (5′), thus by removing said through screw (6) the transmission rod (1) is disconnected for the replacement or maintenance thereof.

1. A connection system of a transmission rod (1) for solar trackers with at least two rows of solar panels (2) the transmission rod (1) of which connects a main rotation shaft (3) with a motorised rotation module (4) to a driven shaft (3′) with a rotation module (4′) without a motor, said transmission rod (1) being connectable to the rotation modules (4, 4′) by means of universal joints (5, 5′) that are fastened to the connection output (4.1, 4.1′) of the rotation module (4, 4′), wherein the universal joint (5, 5′) has at one connection end (5.1, 5.1′) corresponding to the connection output (4.1, 4.1′) of the rotation module (4, 4′), and at the other end of the universal joint (5, 5′) corresponding to a tubular connection output (5.2, 5.2′) with a polygonal cross section for connection to the transmission rod (1), the transmission rod (1) correspondingly having a polygonal configuration, and with a first end (1.1) of the transmission rod (1) longitudinally slidably connectable to the connection output (5.2) of a first universal joint (5) and with a second end (1.1′) of the transmission rod (1) fixedly connectable to the connection output (5.2′) of a second universal joint (5′).

2. The connection system of a transmission rod (1) for solar trackers according to claim 1, wherein the transmission rod (1) is square.

3. The connection system of a transmission rod (1) for solar trackers according to claim 1, wherein the connection output (5.2) of the first universal joint (5) is adjustable by snap fit of the transmission rod (1).

4. The connection system of a transmission rod (1) for solar trackers according to claim 2, wherein the connection output (5.2′) of the second universal joint (5′) is fastened by means of a through screw (6) through a through hole (5.3′) of the connection output (5.2′) of the second universal joint coinciding with a through hole (1.2′) of the second end (1.1′) of the transmission rod (1).

5. The connection system of a transmission rod (1) for solar trackers according to claim 1, wherein the first universal joint (5) is fastened to the connection output (4.1) of the rotation module (4) by means of a grub screw (8).
